(19) United States
(12) Patent Application Publication
(10) Pub. No.: US 2004/0058211 A1
(43) Pub. Date: Mar. 25, 2004

(54) Fuel cell system in a vehicle with an internal combustion engine and method for the operation thereof

(75) Inventors: Joachim Tachtler, Ismaning (DE); Franz-Josef Wetzel, Gernlinden (DE)

Correspondence Address: CROWELL & MORING LLP, INTELLECTUAL PROPERTY GROUP, P.O. BOX 14300, WASHINGTON, DC, 20044-4300, US

(73) Assignee: BAYERISCHE MOTOREN WERKE AKTIENGESELLSCHAFT, Muenchen (DE)

(21) Appl. No.: 10/460,476

(22) Filed: Jun. 13, 2003

Related U.S. Application Data
(63) Continuation of application No. PCT/EP01/13313, filed on Nov. 17, 2001.

(30) Foreign Application Priority Data
Dec. 16, 2000 (DE) 100 62 965.2

(51) Int. Cl. H01M 8/04; H01M 8/06

(52) U.S. Cl. 429/26; 429/19; 429/13; 429/22

(57) ABSTRACT

The invention relates to a fuel cell system in a vehicle with an internal combustion engine. The fuel cell system comprise; at least one fuel cell that can be operated with hydrogen or combustion gas that is produced in a reformer; an internal combustion engine, which is operated with the same or with another combustion gas, and; optionally comprises an auxiliary heating device. In order to increase the overall efficiency of the fuel cell system, the invention provides that an outlet of the fuel cell can be brought into flow connection with an inlet of the internal combustion engine or with an inlet of an auxiliary heating device in order to utilize the excess of combustion gas in the exhaust gas of the fuel cell. The fuel cell is, in particular, operated with a volume flow that ensures a maximum electric power output.

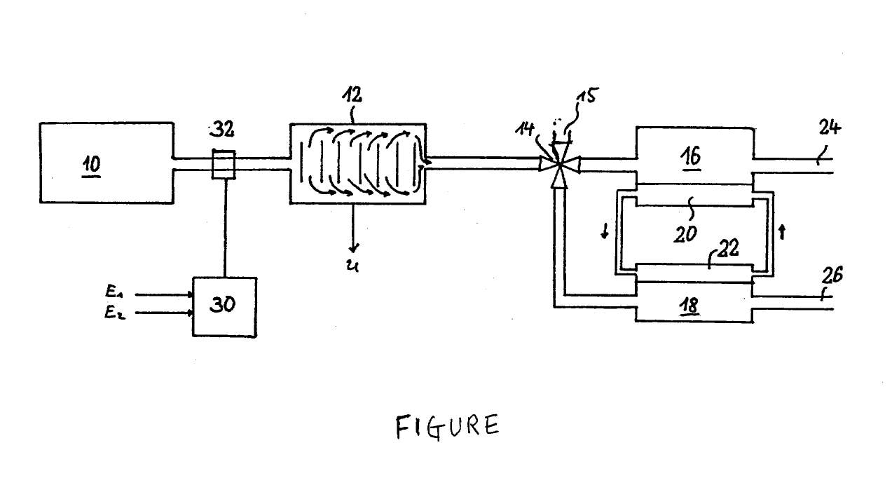

### CROSS REFERENCE TO RELATED APPLICATIONS

The present application is a continuation of International Patent Application No. PCT/EP01/13313, filed Nov. 17, 2001, designating the United States of America and published in German as WO 02/049131, the entire disclosure of which is incorporated herein by reference. Priority is claimed based on Federal Republic of Germany Patent Application No. 100 62 965.2, filed Dec. 16, 2000.

### FIELD OF THE INVENTION

The invention relates to a fuel cell system in a vehicle with an internal combustion engine and a method for the operation thereof.

### BACKGROUND AND SUMMARY OF THE INVENTION

It is known to use a fuel cell to generate electric power in a vehicle. In a special embodiment a conventional internal combustion engine, which drives a crankshaft by way of a piston by burning a combustion gas, is used as the primary drive of the vehicle. Furthermore, a fuel cell for the operation of a vehicle electrical system is used for an engine-independent power supply. The fuel cell is operated, for example, with hydrogen or a combustion gas, produced in a reformer.

The maximum power output of a fuel cell is a function of the volumetric flow rate of a combustion gas. If the fuel cell is supplied with more combustion gas than the electric power requirement demands, then the unconsumed combustion gas is usually released to the environment. In the case of such a method, especially with the use of a reformer conversion, fuel utilization is usually less than 80%.

Furthermore, to achieve a sudden change in the fuel cell's load as in the case of a battery, an adequate amount of a reaction gas must always be available. This feature results conventionally in specifying the delivery of reaction gas to the fuel cell in a buffer container or by means of a complicated regulating system. It is also known to provide a higher volumetric flow rate than necessary. Otherwise, the electric load can be increased only as a function of the load alternation behavior of the reactant supply.

When the electric load is suddenly removed, as stated above, the combustion gas passes unutilized through the fuel cell until the volumetric flow rate can be reduced with a delay to the necessary quantity.

The object of the present invention is to provide a fuel cell system and a method for operating such a system, in which the combustion gas, used for operating the fuel cell, is not needlessly wasted, and the overall efficiency of the system is increased. Yet an adequate electric power output is always provided.

This problem is solved by the embodiments of the invention as described and claimed hereinafter.

A core idea of the present invention consists of providing always an adequate volumetric flow rate of fuel to the fuel cell, so that the maximum electric power output demands can be met. In order not to have to release any existing excess combustion gas from the fuel cell to the environment and to be able to further utilize it, the fuel cell can be connected, according to various embodiments, to either the internal combustion engine and/or to an after-burner. Then the excess combustion gas is fed to these systems, connected in series, and utilized therein.

Altogether the fuel cell is operated in essence at a relatively constant volumetric flow rate of the combustion gas while the internal combustion engine is running. In the medium term this volumetric flow rate is supposed to be designed in such a manner that the maximum electric power output, required instantaneously or in the future, can be generated. If the excess combustion gas is utilized then in the internal combustion engine, it serves the additional drive of the vehicle. When excess combustion gas is utilized in an auxiliary heating device (after-burner), the cooling water for the internal combustion engine can be preheated for example. This feature enables not only lower friction losses of the engine during startup, but also an auxiliary heating function.

When the internal combustion engine is switched off, the quantity of combustion gas is, for example, a function of the main loads, for example an electric air conditioning system or a light.

In order to be able to control the flow of the excess combustion gas to the internal combustion engine or to the auxiliary heating device, a controllable valve is disposed preferably in the appropriate direction of flow. Should this valve have to be closed completely even when the fuel cell is in operation, one should also provide the possibility to ventilate to the environment.

According to an especially preferred embodiment, the excess combustion gas can be fed, and in particular depending on the requirements, selectively to an auxiliary heating device and/or to the internal combustion engine. Appropriate constructive designs must then be provided.

Of course, the fuel cell can always be operated at a maximum volumetric flow rate. According to an especially preferred embodiment, however, the volumetric flow rate is set as a function of the operation. In so doing, a controller evaluates the available input signals, for example the necessary electric power output of different load, and selects a volumetric flow rate for the combustion gas that meets these requirements. In addition to the current power consumption of the active electric devices, such as the air conditioning system, light, energy supply of the controllers, etc., or a foreseeable future power consumption of such devices, other information, such as the additional vehicle operating data and/or the environmental data, can be fed as the input signals to the controller. For example, at low ambient temperatures one can conclude that it is necessary to preheat a vehicle. On the other hand, at high external temperatures, one can conclude that an air conditioning system will be switched on. Should, moreover, so-called brake-by-wire systems be used, then in addition, one must observe, for example, at high speeds, that adequate operating power for the brakes is always available.

A single embodiment of the present invention is explained in detail below with reference to a single drawing.

### BRIEF DESCRIPTION OF THE DRAWING

The FIGURE shows an embodiment of the present invention.

### DETAILED DESCRIPTION OF A PREFERRED EMBODIMENT

The drawing shows a fuel cell 12, which receives hydrogen from a hydrogen tank 10. In the fluid connection between the hydrogen tank 10 and the fuel cell 12 there is a volumetric flow regulator 32 (valve/pump), which is actuated by a controller 30. The controller 30 receives input data E₁, E₂, on the basis of which it calculates the volumetric flow rate for the maximum power output needed and adjusts the volumetric flow rate with the volumetric flow regulator 32. The fuel cell 12 produces electric energy U and provides it, as a function of the demand, to the vehicle electric system, which is not depicted in detail. If now a larger volumetric flow is sent through the fuel cell 12 than is necessary to generate the electric power, then the volumetric flow goes by way of a fuel cell outlet to an internal combustion engine 16 or to an after-burner 18. In so doing, the control of the excess combustion gas is assumed by a valve element 14, which draws off, as a function of the demand, the excess combustion gas to the internal combustion engine 16, the after-burner 18, or, if necessary, to the environment (outlet 15). In the internal combustion engine 16 the excess combustion gas is admixed in an appropriate manner with the rest of the combustion gas. In this respect the particulars are not discussed in detail here. If, in contrast, the excess combustion gas is fed to the after-burner 18, then the cooling water in the cooling circulation 20 of the internal combustion engine 16 is heated by a heat exchanger 22. The resulting exhaust gases from the internal combustion engine 16 or the after-burner 18 respectively are exhausted over the respective outlets 24 and 26 to the environment. If hydrogen is used as the combustion gas, then only water is produced as the exhaust gas.

The present invention offers the simple possibility of operating optimally and altogether efficiently a fuel cell without having to waive the possibility of realizing sudden load changes when supplying power in a vehicle. If in the internal combustion engine a different combustion gas than hydrogen were also to be used, then the cold start emission could also be improved by preheating. In addition, an exhaust gas catalyst could be heated, a feature that also has a positive effect on the emission behavior in the cold start area. Moreover, owing to the use of the combustion gas, an auxiliary heater is available for heating the cooling water; and the engine can be operated with little friction losses at startup. In addition, the system does not need any excessively complicated regulating system and fewer components, a feature that has altogether a positive effect on the costs, the unit volume and the overall weight of the system.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. Fuel cell system in a vehicle with an internal combustion engine, comprising at least one fuel cell, which can be operated with hydrogen or combustion gas that is produced in a reformer; and comprising an internal combustion engine, which is operated with the same or with another combustion gas, wherein an outlet of the fuel cell can be brought into flow connection with an inlet of the internal combustion engine, in order to feed the exhaust gas from the fuel cell into the combustion chamber of the internal combustion engine.

2. Fuel cell system, as claimed in claim 1, wherein a controllable valve element is arranged in the flow connection between the fuel cell and the internal combustion engine.

3. Fuel cell system in a vehicle with an internal combustion engine, comprising at least one fuel cell, which can be operated with hydrogen or combustion gas that is produced in a reformer; and comprising an internal combustion engine, which is operated with the same or with another combustion gas; as well as an auxiliary heating device, which can be operated with a combustion gas, wherein an outlet of the fuel cell can be brought into flow connection with an inlet of the auxiliary heating device, in order to feed the exhaust gas from the fuel cell into the combustion chamber of the auxiliary heating device.

4. Fuel cell system, as claimed in claim 3, wherein the auxiliary heating device serves to heat the cooling water of the internal combustion engine.

5. Fuel cell system, as claimed in claim 4, wherein the outlet of the fuel cell can be brought additionally into flow connection with an inlet of the internal combustion engine, in order to be able to feed selectively the exhaust gas from the fuel cell also into the combustion chamber of the internal combustion engine.

6. Fuel cell system, as claimed in claim 5, wherein in the flow connection between the fuel cell, on the one hand, and the internal combustion engine and the auxiliary heating device, on the other hand, there is a controllable valve element, which determines the exhaust gas flow from the fuel cell to the internal combustion engine and/or to the auxiliary heating device.

7. Fuel cell system, as claimed in claim 6, wherein there is a controller, which comprises inputs for input signals, on the basis of which the volumetric flow rate for operating the fuel cell can be determined; wherein the controller is designed in order to determine from the input signals the maximum power output that is required; and that the controller actuates a regulator, which is arranged in a feed line to the fuel cell and whose purpose is to supply the fuel cell with the determined volumetric flow.

8. Method for operating a fuel cell system, as claimed in claim 7, wherein the data from electric loads, which are active or are to be activated, are fed to the controller, that from these data the maximum electric power output that is to be made available is determined; and that the controller provides the fuel cell with a volumetric flow in order to be able to produce the maximum electric power output.

9. Method, as claimed in claim 8, wherein the information from a main electric consumer is fed to the controller.

10. Method, as claimed in claim 9, wherein additional vehicle operating data and/or environmental data are fed to the controller.

11. Method, as claimed in claim 9, wherein additional vehicle operating data and/or environmental data are fed to the controller.

12. Fuel cell system, as claimed in claim 3, wherein the outlet of the fuel cell can be brought additionally into flow connection with an inlet of the internal combustion engine, in order to be able to feed selectively the exhaust gas from the fuel cell also into the combustion chamber of the internal combustion engine.

13. Fuel cell system, as claimed in claim 3, wherein in the flow connection between the fuel cell, on the one hand, and the internal combustion engine and the auxiliary heating device, on the other hand, there is a controllable valve element, which determines the exhaust gas flow from the fuel cell to the internal combustion engine and/or to the auxiliary heating device.

14. Fuel cell system, as claimed in claim 3, wherein there is a controller, which comprises inputs for input signals, on the basis of which the volumetric flow rate for operating the fuel cell can be determined; that wherein the controller is designed in order to determine from the input signals the maximum power output that is required; and that the controller actuates a regulator, which is arranged in a feed line to the fuel cell and whose purpose is to supply the fuel cell with the determined volumetric flow.

15. A fuel cell system in a vehicle, comprising a fuel cell, which is adapted for use with hydrogen or combustion gas, the fuel cell including an outlet, wherein the outlet of the fuel cell is connected to an inlet of an internal combustion engine to feed exhaust gas of the fuel cell to a combustion chamber of the internal combustion engine.

16. A fuel cell system, as claimed in claim 15, further comprising a controllable valve element that is arranged in the flow connection between the fuel cell and the internal combustion engine.

17. A fuel cell system in a vehicle, comprising a fuel cell including an outlet, an internal combustion engine, and an auxiliary heating device including an inlet and a combustion chamber, wherein the outlet of the fuel cell is connected to the inlet of the auxiliary heating device to feed exhaust gas of the fuel cell to a combustion chamber of the auxiliary heating device.

18. A fuel cell system, as claimed in claim 17, wherein the auxiliary heating device is designed to heat cooling water of an internal combustion engine.

19. A fuel cell system, as claimed in claim 18, wherein the outlet of the fuel cell is connected to an inlet of the internal combustion engine to feed the exhaust gas of the fuel cell to a combustion chamber of the internal combustion engine.

20. A fuel cell system, as claimed in claim 19, further comprising a controllable valve element, which determines how much the exhaust gas flows from the fuel cell to the internal combustion engine or to the auxiliary heating device.

21. A fuel cell system, as claimed in claim 20, further comprising a controller that controls a volumetric flow rate into the fuel cell based on current or future maximum power output required of the fuel cell.

22. A fuel cell system, as claimed in claim 17, wherein the outlet of the fuel cell is connected to an inlet of the internal combustion engine to feed the exhaust gas of the fuel cell to a combustion chamber of the internal combustion engine.

23. A fuel cell system, as claimed in claim 17, further comprising a controllable valve element, which determines how much the exhaust gas flows from the fuel cell to the internal combustion engine or to the auxiliary heating device.

24. A fuel cell system, as claimed in claim 17, further comprising a controller that controls a volumetric flow rate into the fuel cell based on current or future maximum power output required of the fuel cell.

25. A method for operating a fuel cell system, comprising obtaining data relating to active or to be activated electric loads, determining maximum electric power output that is to be made available based on the data, and providing a fuel cell with an appropriate volumetric flow to produce the maximum electric power output.

26. A method, as claimed in claim 25, wherein the data includes data relating to a main electric consumer.

27. A method, as claimed in claim 25, wherein the data includes vehicle operating data or environmental data.
